(19) United States
(12) Patent Application Publication
(10) Pub. No.: US 2003/0154270 A1
(43) Pub. Date: Aug. 14, 2003

(54) Independent and integrated centralized high speed system for data management

(75) Inventor: Robert Aranda JR., Albuquerque, NM (US)

Correspondence Address: Ray R. Regan, LAW OFFICE OF RAY R. REGAN, P.O. Box 1442, Corrales, NM, 87048, US

(73) Assignee: Loss Prevention Management, Inc., New Mexico corporation

(21) Appl. No.: 10/074,334

(22) Filed: Feb. 12, 2002

(51) Int. Cl. G06F 15/173

(52) U.S. Cl. 709/223

(57) ABSTRACT

An independent, integrated centralized high speed system for data management, particularly useful in providing, processing, and reporting surveillance information, is provided. An independent and integrated centralized high speed system for data management, according to the present invention, includes an independent communications network, such as a private network, capable of transmitting data at speeds of not less than 7 frames per second. The present invention also includes one or more data acquisition devices, such as a camera, operably connected to the independent high speed circuit for recording digital images, at least both voice and visual. The data acquisition device also may include one or more data stream processors. One or more voice transmission subsystems may be connected to the independent communications network, such as IP telephony. In addition, at least one client computer for processing the data is provided. At a centralized location a hub is included for receiving the data, a router is provided for transmitting the data through the system, and a server is installed for providing data analysis.

### FIELD OF THE INVENTION

The present invention pertains generally to an independent and integrated centralized high speed system for management of a wide variety of data. More particularly, the new and useful invention claimed in this document pertains to a self-contained centralized interconnected communication network for providing high speed transmittal of audio, visual, telephony and other data across the network, while also providing a number of additional features and capabilities including, for example, telephony communications. The present invention is particularly, but not exclusively, useful for obtaining and transmitting surveillance information from any number of remote sites to a central facility for data processing and management.

### BACKGROUND OF THE INVENTION

The information explosion of recent decades has, in part, driven requirements for enhanced high speed performance by all data transmission components and nodes in data or information transmission networks, systems, or fabrics (in this document, “system” or “systems”). A network is generally considered an aggregation of distributed nodes, where a “node” includes at least all hardware connected across a communications system to transmit data over a network or communications system having a protocol that supports interaction among the nodes. Protocols are, of course, analogous to various languages and dialects used in human speech; to the extent that a node can “understand” which protocol is used, all nodes in a network or system can “speak the same language.” Typically, each node maybe capable of recognizing error conditions on the system, and may provide error management to recover from error conditions. The term “fabric” as used in ths document contemplates at least an active, intelligent interconnection scheme, while a “network,” as indicated, refers to an aggregation of distributed nodes. Data and information include at least information, data, and data packets, but also voice, audio, imagery and video transmissions (collectively in this document, “data”).

Each node in a data transmission system today is challenged to convey data and data packets across interrelated and intrarelated systems with ever increasing speed and accuracy. Demands for high speed, substantially real-time transmission of data has increased significantly, if not exponentially. Consequently, demand for high-performance communications for server-to-storage and server-to-server networking also has increased. In addition, there is a growing need to provide independent high speed data transmission across systems that do not rely entirely on conventional communications systems such as telephone systems, and are more internally secure than conventional communications networks.

Performance improvements in hardware entities, including data acquisition devices, storage apparatus, processors, hubs, routers, servers, and in transmission systems themselves, along with the move to distributed architectures, have increased the demand for data-intensive and high-speed networking applications. Interconnections between and among these systems, and their input/output devices, require enhanced levels of performance in reliability, speed, and distance. Simultaneously, demands for more robust, highly available, disaster-tolerant computing resources, with ever-increasing speed and memory capabilities, continue unabated.

In a particular application of the need for such an independent and integrated centralized high speed system for data management, security and surveillance systems require comparable improvements. The need to confirm limited access to sites and locations that are often remote from owners and users, to monitor employee access to and conduct at such sites, to acquire surveillance information concerning site access or entry by unauthorized third parties, and to gather and process a wide range of information about both a site and any people associated with the site (collectively, “surveillance information”) has accelerated the demand for an independent and integrated centralized high speed system for data management. Apparatus and methods for acquiring and processing surveillance information, often from sites remote from the location of other nodes in a data transmission system, while also preferably satisfying the demand for substantially real-time recordation and delivery of such data, are required by business concerns and government agencies. In addition, demand is rising for including supplementary features in such systems. Supplementary features include, but are not limited to, private telephony subsystems integrated into an independent and integrated centralized high speed system for data management. In addition to speed of transmission of data, users demand reduction in costs, avoidance of data flow or communications bottlenecks during transmission, and increased security.

Indeed, security within the system is not an insignificant objective. An important objective of an independent and integrated centralized high speed system for data management is to achieve a system-wide security in part from substantial independence from conventional, insecure systems. The importance of system security was dramatically emphasized by Microsoft's® decision in a position message sent via e-mail to its employees during the week of Jan. 14, 2002 (“Position Paper”). The Position Paper makes clear that security is of paramount importance, far more important than adding new features to the software. It has become clear that users of all data transmission and communication systems are less interested in new features, but extremely interested in products that are “trustworthy,” meaning secure. Thus, one objective of the present invention is that data transmissions across the system originate and remain secure from unauthorized users. As a minimum, therefore, an objective of the present invention is to allow only authorized users to send a command, such as a ping signal on a TCP/IP network, as a test message to a site or node within the system, and receive a response.

To satisfy such demands, it is necessary to overcome performance problems often associated with conventional data transmission networks, telephony systems, and related equipment. In computer technologies, mainframes, supercomputers, mass storage systems, workstations and very high resolution display subsystems (collectively, “computers”) frequently are interconnected to facilitate data sharing. Because of the demand for increased speed across such conventional systems, clogging of data flow and communication frequently occurs. This is yet another conditions that has prompted increased demand for data management apparatus and methods that are self-contained within an integrated data management system, and that are substantially divorced from conventional communications systems and networks.

Until recently, systems devoted to data transmission often were limited in use because data was transmitted too slowly across the system. In addition, many information and communications systems were required to interface and transmit data across unsecured and often unreliable conventional land-line telephone systems. Innovations in cellular technology did not lessen concerns about lack of security and unreliability. The need to move data in substantially real time across a secured data transmission system was not readily achievable. Also, connecting other subsystems to such conventional systems of data transmission proved costly, cumbersome, slow, and lacked the security demanded by modern commercial and governmental transactions.

Recently, however, a number of discrete yet unrelated hardware, software and system innovations have begun to provide means for overcoming the deficiencies in data and communications transmission systems. Features and components exist for establishing a high-speed data transfer network to connect a variety of nodes and subsystems into self-contained or independent, integrated, and centralized interconnected data management systems. A particular application of such a system would be particularly useful in providing substantially real time acquisition, storage, transmission, viewing, processing, routing, and analyzing of surveillance information from sites that may be remote in distance from other nodes or from centralized subsystems and that achieve substantially real time surveillance information management. In addition, such self-contained or independent, integrated, and centralized interconnected data management systems may include a number of supplementary features, including communications subsystems.

The present invention of an independent and integrated centralized high speed system for data management that may be used in an application of the invention as an apparatus and method for acquiring and processing surveillance data, particularly from sites to be remotely monitored, has proven robust and resilient. The present invention includes at least these features: scalable networking; high performance; rapid data access and backup; reliable data acquisition; and substantially real time acquisition and review of the surveillance data. Likewise, a number of additional subsystems are readily connectable to the independent and integrated centralized high speed system for data management, including telephony subsystems such as IP telephony subsystems.

As indicated, in prior approaches, few means for monitoring and providing surveillance information from a number of sites remote from a surveillance data management center have been suggested. The limitations of the relatively few solutions that have been suggested include at least the failure to provide an independent and integrated or self-contained method and apparatus. Indeed, earlier recommended approaches and procedures were restricted to using conventional publically available telephone and communication systems and networks. Such publically available systems networks are comparatively slow, and fail to provide the high speed transmission of data, including surveillance information, required for modern needs.

Therefore, a previously unaddressed need exists in the industry for a new and useful apparatus that provides an independent and integrated centralized high-speed system for data management. There also exists a significant need for a method and apparatus capable of transmitting surveillance information at high speeds across such a centralized system. In addition, there is a need for such a system to permit inclusion of a wide variety of supplementary features, capable of accommodating at least IP telephony, yet flexible enough to transmit a wide variety of data and information across the network and system.

### SUMMARY OF THE INVENTION

Given the conventional solutions for attempting to solve the problems associated with transmitting data, including surveillance information, it would be desirable, and of considerable advantage, to provide an apparatus and method that provides an independent and integrated centralized high speed system for data management capable of managing data, including surveillance information, in substantially real time.

It will become apparent to one skilled in the art that the claimed subject matter of the present invention as a whole, including the structure of the apparatus, and the cooperation of the elements of the apparatus, combine to result in a number of unexpected advantages and utilities. The advantages and objects of the present invention, and features of the an independent and integrated centralized high speed system for data management will become apparent to those skilled in the art when read in conjunction with the accompanying following description, drawing figures, and appended claims. The advantages include at least the capability to transmit data at significantly higher speeds than current systems provide. Another advantage of the present invention data transmission within a self-contained, integrated communications network, thus enhancing security of the data as well as the system. The present invention also substantially the need to use conventional public transmission lines, grids, and related networks. Also, the present invention provides a network for transmission of data in substantially real time.

Still another advantage of the present invention is provided by centralized management of data transmitted across the system. The present invention includes a private data processing center for managing the data. The importance of centralized data management cannot be overstated. The terms “managing the data,” “data management,” and phrases of similar import, as used in this document, include, but are not limited to, development as well as use of the information contained among the data. The present invention recognizes that one of its unique advantages is recognition that a complete information system includes not just computers and the other interconnected and interrelated nodes on a system, but also people. The people may be employees of a user, customers of a user, even unwanted persons seeking entry to a remote site monitored by the system. Accordingly, a significant feature of the present invention includes the capability it affords a user to define the goals of the user organization; to identify or select from among the huge mass of potentially available data portions of the information actually needed to attain those goals; to assess how best to originate the desirable information using, for example, one or more data acquisition devices, and, or in the alternative, one or more data stream processors; and to individually select the components in which to store, transfer, and process that information within a secure self-contained data flow system.

Yet another advantage of the present invention is an independent and integrated centralized high speed system for data management, and a method for transmitting and managing the data, that respectively are easy to use and to practice, and which are cost effective for their intended purposes.

These and other advantages are achieved in the present invention by providing an independent and integrated centralized high speed system for data management that includes a self-contained communications network for transmitting data across the system. The self-contained communications network may include any of a variety of devices and subsystems, including at least one private network. The private network may consist of an internet protocol private network. The self-contained communications network also may include any of a variety of voice-IP subsystem. The self-contained communications network also is capable of rapidly transmitting data at not less than 7 frames per second across the system without requiring high bandwidth capabilities, which often are unavailable, and when available, comparatively expensive.

The present invention also includes one or more data acquisition devices that may be connected to the high speed network. In one embodiment of the present invention, the data acquisition device is at least one camera capable of recording and transmitting at least digital images across the system. A data acquisition device of the present invention also may be one or more data stream processors capable of recording and transmitting data across the system. The term “data stream processor,” as used in this document, includes a variety of devices capable of acquiring and transmitting data and information, including, without limitation, cash registers, thermostats and other HVAC apparatus, television components, telephones, and any device that may electronically or electrically record data and information of interest to a user of the present invention.

In addition, a private data processing center that includes any number of nodes, including, without limitation, a call manager, is included in the present invention for centralized management of the data. Other nodes are included, including at least one computer for processing data, and which can be operably interconnected with the high speed network and the data acquisition device. The present invention also may be equipped with one or more voice transmission subsystems that may be operably connected to the independent high speed network, including a telephony subsystem.

The advantages and other objects of the present invention, and features of such an integrated and centralized high speed system for data management and transmission, will become apparent to those skilled in the art when read in conjunction with the accompanying following description, drawing figures, and appended claims.

The foregoing has outlined broadly the more important features of the invention to better understand the detailed description which follows, and to better understand the contribution of the present invention to the art. Before explaining at least one embodiment of the invention in detail, it is to be understood that the invention is not limited in application to the details of construction, and to the arrangements of the components, provided in the following description or drawing figures.

The invention is capable of other embodiments, and of being practiced and carried out in various ways. Also, the phraseology and terminology employed in this disclosure are for purpose of description, and should not be regarded as limiting.

As those skilled in the art will appreciate, the conception on which this disclosure is based readily may be used as a basis for designing other structures, methods, and systems for carrying out the purposes of the present invention. The claims, therefore, include such equivalent constructions to the extent the equivalent constructions do not depart from the spirit and scope of the present invention. Further, the abstract associated with this disclosure is neither intended to define the invention, which is measured by the claims, nor intended to be limiting as to the scope of the invention in any way.

The novel features of this invention, and the invention itself, both as to structure and operation, are best understood from the accompanying drawing, considered in connection with the accompanying description of the drawing, in which similar reference characters refer to similar parts, and in which:

### BRIEF DESCRIPTION OF THE DRAWING

FIG. 1 is a schematic view of the an independent and integrated centralized high speed system for data management;

FIG. 2 is a schematic view of a representative distribution of nodes across a private network; and

FIG. 3 is a schematic view of a private data processing center of the present invention interconnected to a private network and a virtual private network.

### DESCRIPTION OF A PREFERRED EMBODIMENT

Briefly, the present invention provides an independent and integrated centralized high speed system for data management. The system includes a self-contained communications network for transmitting data across the system. In a preferred embodiment of the present invention, the self-contained communications network includes at least one private network. Preferably, the private network is an internet protocol private network. The present invention may also include a virtual private network (“VPN”) for conducting voice communications or other data transmissions across the system, but inclusion of a VPN is not a limitation of the present invention. The self-contained communications network also preferably transmits data and data packets at not less than 7 frames per second without the requirement broad band capabilities. Data acquisition devices are included. In one embodiment of the present invention, the data acquisition device is a camera. The camera is capable of recording and transmitting digital images. The data acquisition device also may include one or more data stream processors. As used in this document, a “data stream processor” includes any device or combination of devices and methods for acquiring and transmitting data and information, including, as previously stated, any device for recording data and information that may be transmitted as data across the system of the present invention. In addition, a private data processing center, including, without limitation, a call manager, is included in the present invention. The private data processing center provides centralized data management. A variety of other nodes are included, such as computers. In a preferred embodiment of the present invention, one or more voice transmission subsystems are included, such as a telephony subsystem. The present invention, therefore, is useful for transmitting and managing data of all kinds, including surveillance data from sites located at significant distances from a location where the data is collected and processed.

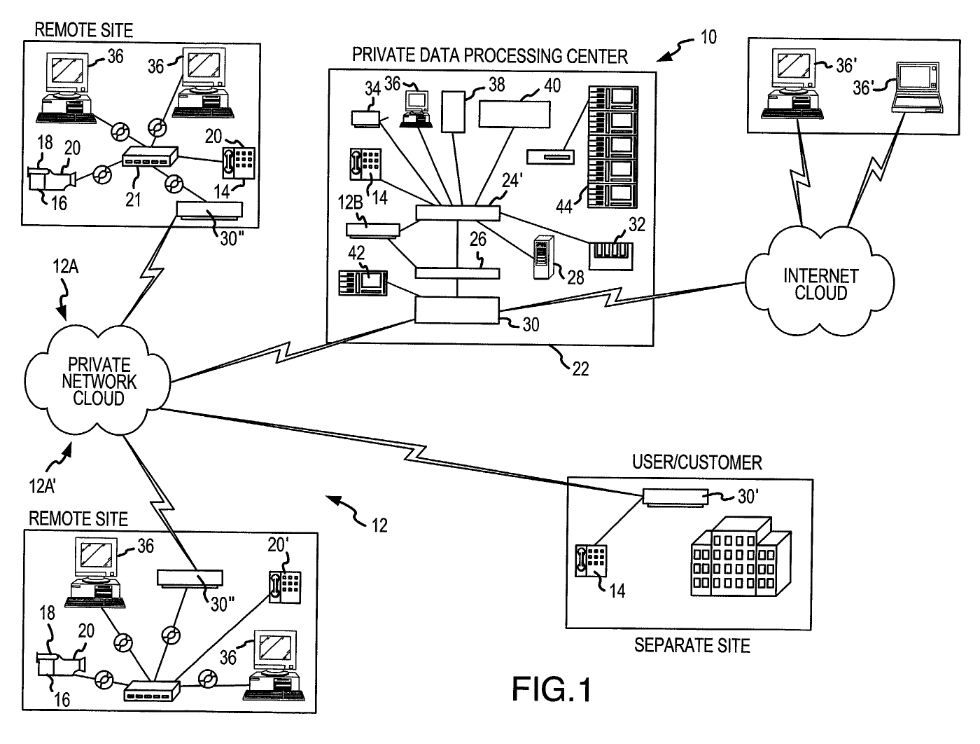

FIG. 1 is a schematic view of the independent and integrated centralized high speed system for data management. Referring initially to FIG. 1, the independent and integrated centralized high speed system for data management is shown and generally designated 10. As shown, independent and integrated centralized high speed system for data management 10 includes at least a self-contained communications network 12 shown in FIG. 1. Accordingly, in a preferred embodiment of the present invention, self-contained communications network 12 includes a private network 12A. Self-contained communications network 12 may also include a virtual private network 12B.

Self-contained communications network 12, in an alternative embodiment of the present invention, may be any alternative independent communications network, fabric, or system (not shown). Self-contained communications network 12 is capable of high speed receipt and delivery of data and information across independent and integrated centralized high speed system for data management 10. As used in this document, the term “independent” refers to a communications network that may stands alone, may not be affiliated with other systems or networks, and may not require or rely on conventional or traditional communications networks that provide, for example, traditional telephone services based on one or more private branch exchanges (“PBX”). Self-contained communications network 12, therefore, which in a preferred embodiment of the present invention includes private network 12A, is substantially self-contained within the invention as a whole. The present invention is a unified high speed network that operates as a self-contained unit. Self-contained communications network 12 also is integrated to provide ubiquitous availability of voice, data, imagery and video data transmission across self-contained communications network 12. Self-contained communications network 12 therefore is substantially independent of operation on the Internet, conventional telephone systems, and subsidiary providers such as Internet service providers.

Self-contained communications network 12, however, in a preferred embodiment of the present invention, but not as an exclusive embodiment of the invention, includes adaptations of Internet technology and protocols for use in combination with self-contained communications network 12. For example, private network 12A, in a preferred embodiment, is an Internet Protocol Private Network (“IP Private Network”) 12A′ shown diagrammatically and schematically in FIG. 1. IP Private Network 12A′ uses technologies associated with Internet Protocols that connect nodes in a system, and allow transmission of data across, an Internet Protocol cloud, as also shown in FIG. 1. In the preferred embodiment of the present invention IP Private Network 12A′ is a UUNET® IP network by Worldcom®. Inclusion of a UUNET® IP network by Worldcom® is not a limitation of the present invention, but is only one example of a private network used in connection with one embodiment of the present invention. Use of a UUNET® IP network by Worldcom® as the at least one private network included in self-contained communications network 12 takes advantage of tunneling technologies by providing broadband connectivity to the public Internet as well as to private resources. As a result, IP-encapsulated packets of data may be transmitted across independent and integrated centralized high speed system for data management 10, a private network, without requiring use of public infrastructure such as the Internet, while using Internet protocols and technologies.

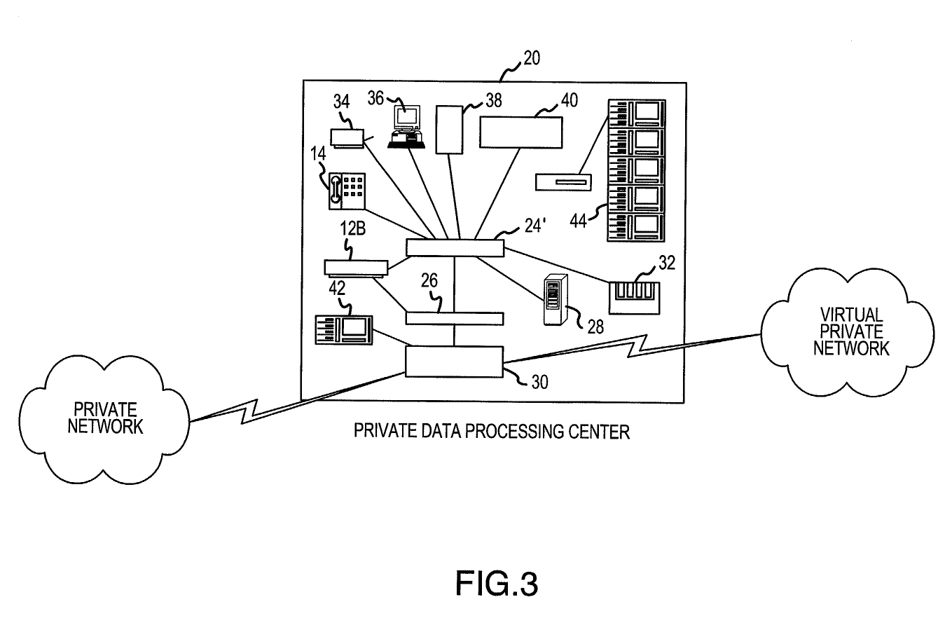

To the extent that VPN 12B is deemed a useful addition to the present invention, its inclusion is indicated by cross-reference between FIGS. 1 and 3, in the form of an end-to-end, wide-area-network constructed on the Internet Protocol (“IP”) that provides the reach and efficiency of a public network, with the performance and security of a private network. Self-contained communications network 12 permits use of Voice-over-Internet Protocol (“VoIP”) technology. The present invention, therefore, is useful not only for large users of data transmission, but also small and medium sized entities. In part, this is achieved because conventional telephone lines will terminate at the private data processing center, or the central data management subsystem, described below, permitting voice mail and distributed dial plans, as well as other voice, data, imagery and video data transmissions, to be sent, received and managed by and within the present invention. This achievement substantially eliminates the need for conventional telephone equipment.

In a preferred but not exclusive embodiment of the present invention, private network 12A is a Worldcom® product. The use of private network 12A in connection with self-contained communications network 12 provides the advantages of enhanced security, performance, scalability, and manageability. A seamless configuration allows data to be collected between all nodes within private network 1 2A. As previously stated in this document, the term “node” includes at least any and all hardware connected across self-contained communications network 12 having a protocol that supports interaction among the nodes. As indicated, protocols are analogous to various languages and dialects used in human speech; to the extent that a node can “understand” which protocol is used, all nodes in a network or system can “speak the same language.” Typically, each node may be capable of recognizing error conditions on the system, and may provide error management to recover from error conditions.

At least one advantage of the present invention is to recognize and adapt the technological convergence in the fields of computers and telephony, as computer technologies continues to not only control but manage private or independent systems and networks. Computers and related peripherals may control telephones as well as conduct telephony functions. In addition, data or information carried over conventional telephone lines may be detected by computers and used to handle telephone calls more efficiently. A need to bring together people and nodes located in different locations who need to work together also is driving convergence of the two technologies. Use of self-contained communications network 12 therefore contributes to increasing security of the information and data within such an independent network. Accordingly, a preferred embodiment of the present invention also includes at least one or more telephones 14 as shown by FIG. 1. One or more telephones 14 may IP protocol telephones that will convert analog voice signals into data packets before transmitting the data packets to an enterprise gateway server that no longer will be required to form or reform data packets of the voice stream. One or more IP protocol telephones 14 is not a limitation of the present invention, but is only one example of the advantages of a node that may be included with virtual private network 12B used in connection with one embodiment of the present invention.

As also shown in FIG. 1, independent and integrated centralized high speed system for data management 10 also includes one or more data acquisition devices 16. One or more data acquisition devices 16 may be located at a remote site. The term “remote site” as used in this document means a site that may be geographically distant from other nodes interconnected across independent and integrated centralized high speed system for data management 10. In one embodiment of the present invention, one or more data acquisition devices 16 are one or more cameras 18 as shown in FIG. 1. In a preferred embodiment of integrated and centralized high speed system for data management and transmission 10, one or more cameras 18 are operably connectable to self-contained communications network 12. One or more cameras 18 further are capable of recording digital video images, and of registering audio and video information in reproducible format. In a preferred embodiment of the present invention, cameras 18 are capable, in combination with self-contained communications network 12 of transmitting no fewer than seven frames per second across self-contained communications network 12. In addition, one or more cameras 18 are capable of compressing video data, and recording more than one video data stream simultaneously. The concept of data compression as used in this document includes at least the storage of data in a way that allows the data to occupy less space than if stored in its original form. One or more cameras 18 may also include programmable software for transmission of audio and video information; for enabling simultaneous recordation and viewing of images, including an interrelated sequence of images; and to perform a range of functions tailored to satisfy the unique demands of a particular user. In a preferred embodiment of the present invention, cameras 18 also are equipped to substantially simultaneously record and view digital images consisting of surveillance information, particularly where the surveillance is obtained at a site remote from other nodes interconnected with self-contained communications network 12. One or more cameras 18 also are able to substantially simultaneously record visual information at more than one site, and from more than one node located across self-contained communications network 12. In a preferred embodiment of integrated and centralized high speed system for data management and transmission 10, one or more cameras 18 shown in FIG. 1 is a local-area-network (“LAN”) digital video camera manufactured by Axcess, Inc. A video camera manufactured by Axcess, Inc is not a limitation of the present invention, but is only one example of one or more cameras 18 that may be used in connection with one embodiment of the present invention.

One or more data acquisition devices 16 is not limited to being one or more cameras 18.

Either in combination with one or more cameras 18, or standing alone, one or more data acquisition devices 16 may include one or more data stream processors 20. As previously stated, the term “data stream processor” as used in this document includes any number of devices and methods for acquiring and transmitting data and information, including, without limitation, cash registers, thermostats, television components (not shown), telephones or any device capable of electronically recording data and information that may be of interest to a user located at a separate site as shown in FIG. 1. As a nonexclusive example of the use of one or more data stream processors 20, in operation a user located at the separate site shown in FIG. 1 may want to monitor the temperature within a structure at a remote site, also shown in FIG. 1. Use of a thermostat or thermostats at the remote site as data stream processors 20 to send data across self-contained communications network 12 would be appropriate.

As also shown in FIGS. 1 and 3, a hub 21 is provided. In a preferred embodiment of the present invention, hub 21 is an Ethernet switch or switches. Use of an Ethernet switch is, however, not a limitation on the present invention, and hub 21 may include one or more variations of switches, including fibre channel switches (not shown). At least one switch proving effective in connection with the present invention is the Cisco® Catalyst® 4224 Access Gateway Switch capable of providing IP routing, Ethernet switching, and voice gateway capabilities. The Catalyst 4224 switch supports quality of service based on Institute of Electrical Electronic Engineers 802.1 p class of service, as well port-based prioritization. The Catalyst 4224 switch, however, is not a limitation of the present invention, but is only one example of a hub that may be used in connection with one embodiment of the present invention. Hub 21 contributes to the objective of providing centralized call processing features through the private data processing center described below. Centralized call processing provides increased employee productivity and lower costs, while simultaneously providing centralized management and maintenance of applications to the data management process. Applications may be centrally located where the private data processing center is installed, and accessed through a wide-area-network.

FIG. 1 also shows that independent and integrated centralized high speed system for data management 10 also includes a private data processing center 22. In this document a private data processing center is also described as a central data management subsystem. At least one private data processing center 22 is operably connectable to one or more data acquisition devices 16 and to self-contained communications network 12 for receiving and processing data and data packets across self-contained communications network 12. In a preferred embodiment of the present invention, as shown in FIG. 1, private data processing center 22 includes a variety of nodes and machines capable of storing data and executing instructions on data. As a nonexclusive example, in a preferred embodiment of the present invention, private data processing center 22 includes a switch 24. Switch 24 also may be a switch stack 24′ as shown by cross reference between FIGS. 1 and 3. In a preferred embodiment of the present invention, private data processing center 22 also includes a firewall 26 to enhance security in connection with data transmitted to private data processing center 22. Private data processing center 22A also includes one or more servers 28 capable of providing a variety of services to other nodes within private data processing center 22. Private data processing center 22 also includes one or more routers 30. As used in this document, a “router” includes but is not limited to a device that connects two or more networks and routes incoming data packets to the appropriate network. Router 30 is shown in FIG. 1 routing data to and between private network 12A and virtual private network 12B. In a preferred embodiment of the present invention, router 20 is a Cisco® router 3600, but use of a Cisco® router 3600 is not a limitation of the present invention, but is only one example of a router used in connection with one embodiment of the present invention. Private data processing center 22 also includes one or more call managers 32 for managing voice messages being transmitted across independent and integrated centralized high speed system for data management 10 as diagrammatically shown in FIG. 1 and FIG. 3 by the broken electrical symbols. In a preferred embodiment of the present invention, private data processing center 22 also includes one or more private facsimile machines 34, a computer 36 that maybe used for a number of administrative tasks, an e-mail server 38, and a cache engine 40. Cache engine 40 allows data storage to avoid having to read data from a slower device such as a disk (not shown) in computer 36, and to hold files to avoid having to download the same materials repeatedly. A web server 42 also is included in the preferred embodiment of the present invention. In addition, a server stack 44 is included for providing a variety of server tasks depending on a user's or subscriber's level of demand for services in connection with independent and integrated centralized high speed system for data management 10. As also shown by cross-reference between FIGS. 1 and 3, connectivity among the various nodes of independent and integrated centralized high speed system for data management 10, in a preferred embodiment, is further enhanced by use of one or more computers 36′ and 36″ for connecting across the Internet cloud using one or more high speed modems (not shown) to process voice, image, or other data.

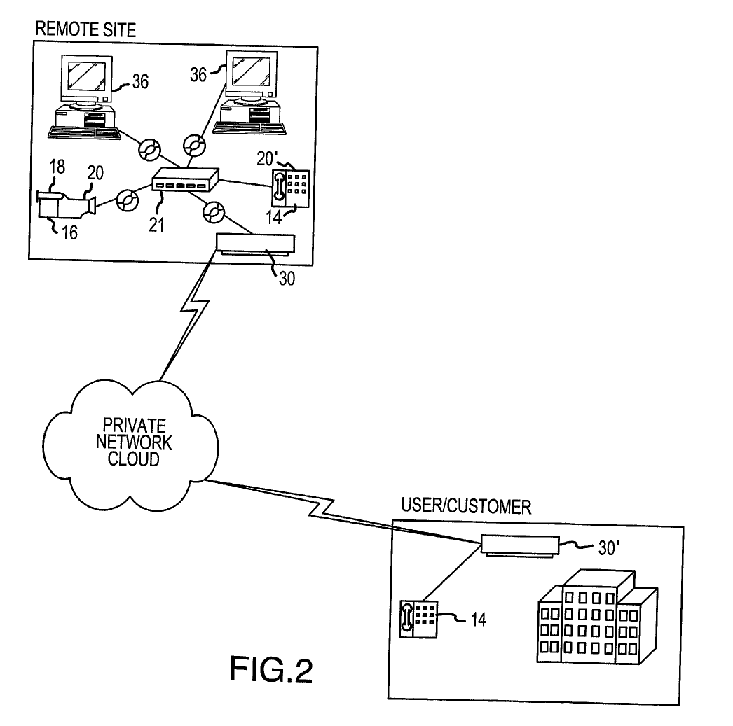

While the independent and integrated centralized high speed system for data management 10 shown in drawing FIGS. 1-3 is at least one embodiment of the present invention, it is merely one embodiment, is not intended to be exclusive, and is not a limitation of the present invention. While the particular independent and integrated centralized high speed system for data management 10 as shown and disclosed in detail in this instrument is fully capable of obtaining the objects and providing the advantages stated, this disclosure is merely illustrative of the presently preferred embodiments of the invention, and no limitations are intended in connection with the details of construction, design or composition other than as provided and described in the appended claims.

Claim elements and steps in this document have been numbered solely as an aid in readability and understanding. The numbering is not intended to, and should not be considered as, intending to indicate the ordering or sequencing of elements and steps in the claims.

1. An independent and integrated centralized high speed system for data management, comprising:
a self-contained communications network for transmitting data across the system;
one or more data acquisition devices operably connectable to the self-contained communications network for recording and transmitting data;
means for transmitting the data across the system; and
a private data processing center interconnectable with the one or more data acquisition devices, and means for transmitting the data across the system, for managing the data.

2. An independent and integrated centralized high speed system for data management as provided in claim 1, wherein the system is equipped to transmit the data across the system at not less than 7 frames per second.

3. An independent and integrated centralized high speed system for data management as provided in claim 1, wherein the self-contained communications network includes at least one private network.

4. An independent and integrated centralized high speed system for data management as provided in claim 3, wherein the at least one private network is an internet protocol private network.

5. An independent and integrated centralized high speed system for data management as provided in claim 1, wherein the one or more data acquisition devices includes one or more data stream processors.

6. An independent and integrated centralized high speed system for data management as provided in claim 1, wherein the transmitting means includes at least one or more switches.

7. An independent and integrated centralized high speed system for data management as provided in claim 1, wherein the one or more data acquisition devices includes one or more cameras.

8. An independent and integrated centralized high speed system for data management as provided in claim 1, wherein the one or more data acquisition devices is equipped to substantially simultaneously record and transmit the data.

9. An independent and integrated centralized high speed system for data management as provided in claim 1, wherein the one or more data acquisition devices is equipped to substantially simultaneously record audio information.

10. An independent and integrated centralized high speed system for data management as provided in claim 1, wherein the one or more data acquisition devices is equipped to compress the data.

11. An independent and integrated centralized high speed system for data management as provided in claim 1 0, wherein the one or more cameras is equipped to substantially simultaneously record visual information from more than one node on the system.

12. An independent and integrated centralized high speed system for data management as provided in claim 1, wherein the private data processing center includes at least one call manager.

13. An independent and integrated centralized high speed system for data management as provided in claim 1, wherein the private data processing center includes at least one router.

14. An independent and integrated centralized high speed system for data management as provided in claim 1, wherein the private data processing center includes on e or more means for conducting data across the private network.

15. An independent and integrated centralized high speed system for data management as provided in claim 1, further comprising one or more voice transmission subsystems operably connectable to the independent communications network.

16. A self-contained method for managing data, comprising:
selecting one or more data acquisition devices;
connecting the one or more data acquisition devices to an independent high speed network;
including at least one central data management subsystem operably connectable to the one or more data acquisition devices and to the independent high speed network for receiving and processing a flow of data across the independent high speed network;
transmitting the data across the independent high speed network at no slower than seven frames per second without broadband capability; and
processing the data to provide substantially real time information.

17. A self-contained method for managing data as recited in claim 16, wherein the one or more data acquisition devices selecting step includes the substeps of:
installing one or more data stream processors for receiving, recording, and sending the data; and
providing programmable software for transmitting and processing the data.

18. A self-contained method for managing data as recited in claim 16, wherein the one or more data acquisition devices selecting step further includes the substeps of:
selecting at least one camera;
installing the at least one camera on the independent high speed network for providing audio and visual data;
compressing audio and video data;
including means for recording more than one video data stream substantially simultaneously; and
providing software to enable simultaneous recording and viewing of images.

19. A self-contained method for managing data as recited in claim 16, wherein the independent high speed network connecting step includes the substep of interconnecting the one or more data acquisition devices and the at least one central data management subsystem to at least one private network.

20. A self-contained method for managing data as recited in claim 16, wherein the independent high speed network connecting step includes the substep of interconnecting the one or more data acquisition devices and the at least one central data management subsystem to at least one internet protocol private network.

21. A self-contained method for managing data as recited in claim 19, further comprising the substep of disposing at least one telephony subsystem for voice transmission over the independent high speed network.

22. A self-contained method for managing data as recited in claim 21, wherein the at least one central data management subsystem including step includes the substeps of:
receiving the data from more than one source;
collecting the data in one or more machines capable of storing the data;
executing instructions on the data;
transmitting the data to other nodes on the independent high speed network; and
routing incoming data to a data repository;

23. A self-contained method for managing data as recited in claim 22, wherein the data processing step includes the substep of providing software to present the data in human useable format.

24. An apparatus for monitoring a remote site, comprising:
one or more private networks,
wherein the one or more private networks can transmit data at seven frames per second;
one or more data acquisition devices operably connectable to the one or more private networks;
at least one data processing center interconnectable with the one or more private networks and the one or more data acquisition devices;
means for transmitting the data across the system; and
an internet protocol telephony subsystem connectable to the one or more private networks.

25. An apparatus for monitoring a remote site as recited in claim 24, wherein the one or more private networks is capable of transmitting voice data packets across the system.

26. An apparatus for monitoring a remote site as recited in claim 24, wherein the one or more data acquisition devices includes software for substantially simultaneous recording and viewing of data related to images.

27. An apparatus for monitoring a remote site as recited in claim 26, wherein the one or more data acquisition devices is a camera operably connectable to the one or more private networks for receiving, recording, and sending surveillance data across the one or more private networks.

28. An apparatus for monitoring a remote site as recited in claim 27, wherein the one or more data acquisition devices includes means for processing the data across the one or more private networks.

29. An apparatus for monitoring a remote site as recited in claim 24, further comprising an Ethernet switch for transmitting ranges of frequencies.

30. An apparatus for monitoring a remote site as recited in claim 29, further comprising one or more routers.

31. A method for acquiring and processing surveillance information, comprising:
installing at least one independent data transmission system capable of high speed receipt and delivery of data;
connecting at least one surveillance information acquisition device to the independent data transmission system; and
including a plurality of devices interconnectable with the independent data transmission system capable of:
(1) accumulating the surveillance information from the at least one surveillance data acquisition device;
(2) transmitting the surveillance information to a central data management facility;
(3) routing the surveillance information to one or more subsystems for data storage;
(4) storing the surveillance information;
(5) updating the surveillance information;
(6) analyzing surveillance information;
(7) reporting the surveillance information on demand;
(8) providing telephonic communications across the at least one independent data transmission system; and
(9) continually repeating steps (1) through (8).

32. A method for acquiring and processing surveillance information as recited in claim 31, wherein the at least one independent data transmission system installing step includes the substep of installing a system usable with at least private branch exchanges and the Internet.

33. A method for acquiring and processing surveillance information as recited in claim 31, wherein the at least one surveillance data acquisition device connecting step includes the substeps of:
installing one or more data stream processors capable of receiving, recording, and transmitting the surveillance information across the at least one independent data transmission system;
providing software for processing and transmitting the surveillance information across the at least one independent data transmission system;
compressing the surveillance information;
recording and transmitting more than one stream of surveillance information simultaneously; and
recording and viewing the surveillance information substantially simultaneously.

34. A method for acquiring and processing surveillance information as recited in claim 31, further comprising one or more telephony devices connectable to the at least one independent data transmission system.

35. An integrated centralized high speed system for data management of remotely acquired digital data, comprising:
at least one high speed network for transmitting the digital data;
means connectable to the at least one high speed network for acquiring the digital data;
means operably connectable to the digital data acquiring means for transmitting the digital data across the system; and
means for processing the digital data to achieve data management.

36. An integrated centralized high speed system for data management of remotely acquired digital data as recited in claim 35, further comprising one or more subsystems for audio communication.

37. An integrated centralized high speed system for data management of remotely acquired digital data as recited in claim 35, wherein the digital data acquiring means includes at least one camera.

38. An integrated centralized high speed system for data management of remotely acquired digital data as recited in claim 35, wherein the at least one camera records audio and visual signals.

39. An integrated centralized high speed system for data management of remotely acquired digital data as recited in claim 38, wherein the at least one camera substantially simultaneous records and views an interrelated sequence of images.

40. An integrated centralized high speed system for data management of remotely acquired digital data as recited in claim 39, wherein the at least one camera compresses data.

41. An integrated centralized high speed system for data management of remotely acquired digital data as recited in claim 40, wherein the at least one camera records video data from more than one source substantially simultaneously.

42. An integrated centralized high speed system for data management of remotely acquired digital data as recited in claim 41, wherein the independent high speed system for conducting the digital data transmits voice and video data.

43. An integrated centralized high speed system for data management of remotely acquired digital data as recited in claim 42, wherein the receiving and processing means includes one or more cameras equipped to substantially simultaneously record and view the digital data.

44. An integrated centralized high speed system for data management of remotely acquired digital data as recited in claim 34, wherein the digital data acquiring means is at least one data stream processor.

45. An integrated centralized high speed system for data management of remotely acquired digital data as recited in claim 34, wherein the digital data receiving and processing means is a private data processing center.

46. An integrated centralized high speed system for data management of remotely acquired digital data as recited in claim 34, wherein the data management processing means includes at least one switch.
